(19) United States
(12) Patent Application Publication
(10) Pub. No.: US 2026/0135170 A1
(43) Pub. Date: May 14, 2026

(54) Contactor Sequencing for a Battery

(71) Applicant: Caterpillar Inc., Peoria, IL (US)

(72) Inventors: James Kieran MCCLOSKEY, Lincolnshire (GB); Michael David SMITH, Cambridgeshire (GB); Robert David BUSBY, Cambridgeshire (GB); Joseph Oluwagbeminiyi OYEKAN, Cambridgeshire (GB); V Kameswara Kiran RAJALA, Kakinada (IN)

(73) Assignee: Caterpillar Inc., Peoria, IL (US)

(21) Appl. No.: 19/120,682

(22) PCT Filed: Sep. 18, 2023
(86) PCT No.: PCT/US2023/074430

§ 371 Date: Apr. 11, 2025

(30) Foreign Application Priority Data
Oct. 14, 2022 (GB) 2215213.6

(51) Int. Cl. H01M 10/44; B60L 58/18; H01M 10/42; H02J 7/00; H02J 7/50; H02J 7/62; H02J 7/68

(52) U.S. Cl. CPC H01M 10/441; B60L 58/18; H01M 10/425; H02J 7/575; H02J 7/585; H02J 7/62; H02J 7/68; H02J 7/855; H01M 2010/4271

(57) ABSTRACT

A method of controlling contactor sequencing for a battery, wherein the battery comprises a circuit. The method comprises determining an architecture of the circuit, wherein the circuit comprises at least a positive contactor assembly and a negative contactor assembly. A direction of current flow through the circuit is determined. Ratings are determined for the positive and negative contactor assemblies for current flow in a first direction and a second direction. The method comprises determining a sequence of switching the contactor assemblies based on at least one of: the priorities assigned to the positive contactors; the priorities assigned to the negative contactors; the direction of current flow; the first and second ratings of the positive contactor assembly; and the third and fourth ratings of the negative contactor assembly. The method further comprises switching the contactor assemblies according to the sequence.

### FIELD OF THE DISCLOSURE

The disclosure relates to the field of battery management.

### BACKGROUND

It is known for battery management software to have safety requirements that require contactors within the battery to be opened in a certain sequence. This may be achieved by control logic that aims to prevent damage to current carrying components and fuses, such as that caused by an inrush current. The control logic may also aim to prolong the lifetime of the contactors, by trying to keep the current flow through the contactors low prior to a contactor open command. Typically, different control logic is required for different battery architectures, voltages and contactor types, and so the same battery management software cannot be used for different battery types.

### SUMMARY OF THE DISCLOSURE

Against this background, there is provided a method of controlling contactor sequencing for a battery, wherein the battery comprises a circuit. The method comprises determining an architecture of the circuit, wherein the circuit comprises at least a positive contactor assembly and a negative contactor assembly. When the positive contactor assembly comprises more than one positive contactor, the method further comprises assigning a priority to each positive contactor of the positive contactor assembly. When the negative contactor assembly comprises more than one negative contactor, the method further comprises assigning a priority to each negative contactor of the negative contactor assembly. The method further comprises determining a direction of current flow through the circuit, wherein the direction of current flow is indicative of whether the battery is charging or discharging. The method further comprises determining a first rating of the positive contactor assembly for current flow in a first direction, a second rating of the positive contactor assembly for current flow in a second direction, a third rating of the negative contactor assembly for current flow in a first direction and a fourth rating of the negative contactor assembly for current flow in a second direction. The method further comprises determining a sequence of switching the positive and negative contactor assemblies based on at least one of: when the positive contactor assembly comprises more than one positive contactor the priority assigned to each of the positive contactors; when the negative contactor assembly comprises more than one negative contactor, the priority assigned to each of the negative contactors; the direction of current flow; the first and second ratings of the positive contactor assembly; and the third and fourth ratings of the negative contactor assembly. The method further comprises switching the positive and negative contactor assemblies according to the sequence.

In this way, it is possible to adapt the method of controlling contactor sequencing to different circuit architectures, contactor properties, current directions, and user preferences. Priorities may be assigned to contactors based on the application (for example requirements for current flow or failure modes) or on contactor properties.

There is also provided a battery comprising a circuit, wherein the circuit comprises a plurality of contactors; and a controller configured to control contactor sequencing for the battery. The controller is configured to determine an architecture of the circuit, wherein the circuit comprises at least a positive contactor assembly and a negative contactor assembly. When the positive contactor assembly comprises more than one positive contactor, the controller is further configured to assign a priority to each positive contactor of the positive contactor assembly; when the negative contactor assembly comprises more than one negative contactor, the controller is further configured to assign a priority to each negative contactor of the negative contactor assembly. The controller is further configured to determine a direction of current flow through the circuit, wherein the direction of current flow is indicative of whether the battery is charging or discharging. The controller is further configured to determine a first rating of the positive contactor assembly for current flow in a first direction, a second rating of the positive contactor assembly for current flow in a second direction, a third rating of the negative contactor assembly for current flow in a first direction and a fourth rating of the negative contactor assembly for current flow in a second direction. The controller is further configured to determine a sequence of switching the positive and negative contactor assemblies based on at least one of: when the positive contactor assembly comprises more than one positive contactor, the priority assigned to each of the positive contactors; when the negative contactor assembly comprises more than one negative contactor, the priority assigned to each of the negative contactors; the direction of current flow; the first and second ratings of the positive contactor assembly; and the third and fourth ratings of the negative contactor assembly. The controller is further configured to switch the positive and negative contactor assemblies according to the sequence.

### BRIEF DESCRIPTION OF THE DRAWINGS

A specific embodiment of the disclosure will now be described, by way of example only, with reference to the accompanying drawings in which:

FIG. 1 shows a flowchart illustrating a method of controlling contactor sequencing for a battery according to an embodiment of the present disclosure.

FIG. 2 shows a flowchart illustrating a method of controlling contactor sequencing for a battery according to an embodiment of the present disclosure.

FIG. 3 shows a battery circuit, wherein a method of controlling contactor sequencing for the battery is provided according to an embodiment of the present disclosure.

### DETAILED DESCRIPTION

A method is provided for controlling contactor sequencing for a battery, wherein the battery comprises a circuit. The method is flexible, such that the method is adaptable to different circuit architectures, contactor properties, current directions, and preferences.

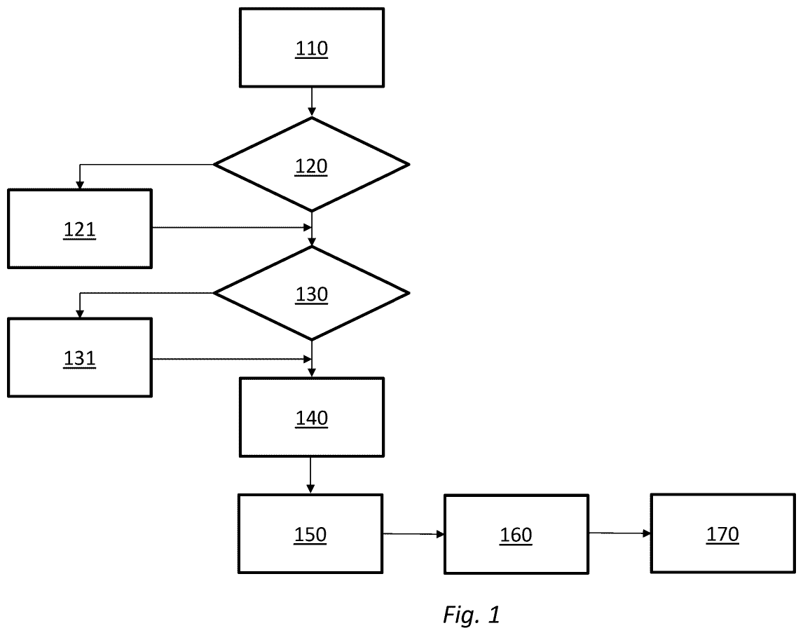

With reference to FIG. 1, according to an embodiment of the present disclosure a method of controlling contactor sequencing for a battery, wherein the battery comprises a circuit, comprises determining an architecture of the circuit at step 110. The circuit comprises at least a positive contactor assembly and a negative contactor assembly. In an event that the positive contactor assembly comprises more than one positive contactor (illustrated at step 120), the method comprises assigning a priority to each positive contactor at step 121. In an event that the negative contactor assembly comprises more than one negative contactor (illustrated at step 130), the method comprises assigning a priority to each negative contactor at step 131. The method further comprises determining a direction of current flow through the circuit at step 140, wherein the direction of current flow is indicative of whether the battery is charging or discharging. At step 150, the method further comprises determining a first rating of the positive contactor assembly for current flow in a first direction, a second rating of the positive contactor assembly for current flow in a second direction, a third rating of the negative contactor assembly for current flow in a first direction and a fourth rating of the negative contactor assembly for current flow in a second direction. At step 160, the method further comprises determining a sequence of switching the contactor assemblies based on at least one of: the priorities assigned to the positive contactors; the priorities assigned to the negative contactors; the direction of current flow; and the first and second ratings of the positive contactor assembly; and the first and second ratings of the negative contactor assembly. At step 170, the method comprises switching the contactor assemblies according to the sequence.

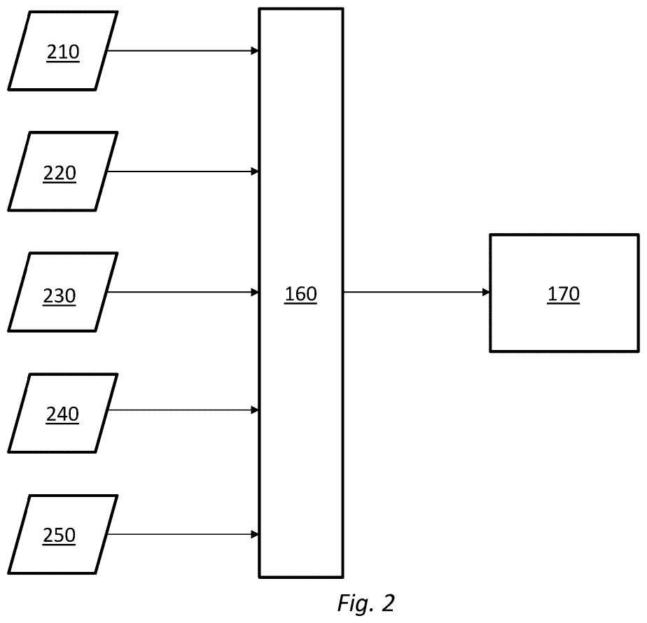

The steps 110 to 150 of the method illustrated in FIG. 1 may be carried out in any order. The outputs of steps 110 to 150 are used in step 160 to determine the sequence of switching the contactors. Another illustration of the method is shown in FIG. 2, wherein the outputs of steps 110 to 150 are the architecture of the circuit 210, the priority of each positive contactor 220, the priority of each negative contactor 230, the direction of current flow through the circuit 240, and the ratings of the contactors 250. The outputs 210 to 250 are used as inputs to step 160 of determining the sequence. At least outputs 220 and 230 are optional, and are used in an event that the positive contactor assembly comprises more than one positive contactor or in an event that the negative contactor assembly comprises more than one negative contactor, respectively. At step 170, the method comprises switching the contactor assemblies according to the sequence.

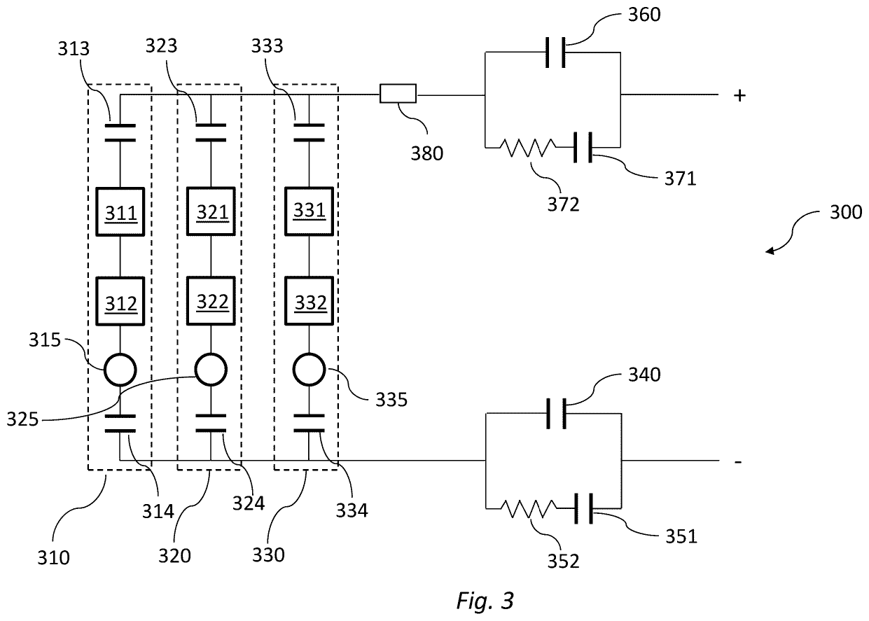

At step 110 of the method, the architecture of the circuit is determined. With reference to FIG. 3, an example of a battery circuit 300 is illustrated. The battery circuit 300 may comprise one or more strings, wherein each string may comprise one or more battery cells. The example illustrated in FIG. 3 shows three strings (each shown enclosed by dashed rectangles 310, 320 and 330), each comprising two cells 311, 312, 321, 322, 331 and 332. In other examples, the battery circuit may comprise one or more strings, and each string may comprise one or more cells. The strings 310, 320 and 330 illustrated in FIG. 3 each comprise a positive contactor 313, 323, 333, a negative contactor 314, 324, 334, and an ammeter 315, 325, 335. The battery circuit 300 further comprises a main negative contactor 340, a pre-charge negative contactor 351 and pre-charge negative resistor 352, a main positive contactor 360, and a pre-charge positive contactor 371 and pre-charge positive resistor 372. The example battery circuit 300 comprises positive and negative contactors in each string, a main positive and negative contactor, and a pre-charge positive and negative contactor. The battery circuit 300 may further comprise a fuse 380.

In other battery circuit architectures, only some of those contactors and components may be present. The circuit comprises a positive contactor assembly and a negative contactor assembly, each of which may comprise one or more contactors. The strings may comprise both positive and negative contactors, or one of the positive and negative contactors, or no contactor. The battery circuit may comprise pre-charge contactors on both the negative and the positive side, or on one of the negative and positive side, or may comprise no pre-charge contactors. The battery circuit may comprise main contactors on both the negative and the positive side, or on one of the negative and positive side, or may comprise no main contactors. With reference to step 110 above of determining the architecture, the positive contactor assembly may comprise one or more of a positive main contactor and a positive string contactor. The negative contactor assembly may comprise one or more of a negative main contactor and a negative string contactor.

In an event that the positive contactor assembly comprises more than one positive contactor, a priority is assigned to each positive contactor. In particular, in an event that the positive contactor assembly comprises a main positive contactor and string positive contactors, a priority may be assigned to the main positive contactor and to the string positive contactors, such that in response to an instruction to switch the positive contactor assembly the order of switching the main positive contactor will depend on the priorities assigned to the main positive contactor and the string positive contactors. Each string positive contactor may be assigned the same priority, or different priorities. The priority assigned to the string positive contactors may be assigned to the string positive contactors as a group. Further priorities may be assigned to the individual string positive contactors. The priorities may be predefined, for example via a calibration.

In an event that the negative contactor assembly comprises more than one negative contactor, a priority is assigned to each negative contactor. In particular, in an event that the negative contactor assembly comprises a main negative contactor and string negative contactors, a priority may be assigned to the main negative contactor and to the string negative contactors, such that in response to an instruction to switch the negative contactor assembly the order of switching the main negative contactor will depend on the priorities assigned to the main negative contactor and the string negative contactors. Each string negative contactor may be assigned the same priority, or different priorities. The priority assigned to the string negative contactors may be assigned to the string negative contactors as a group. Further priorities may be assigned to the individual string negative contactors. The priorities may be predefined, for example via a calibration.

At step 140, the direction of current flow through the circuit is determined. At step 150, ratings of the positive and negative contactor assemblies are determined for each direction of current flow. The positive and negative contactor assemblies may comprise unidirectional contactors, or may comprise contactors with higher ratings for current flow in one direction than the other. Otherwise, the positive and negative contactor assemblies may comprise bi-directional contactors with the same rating for current flow in each direction.

In an event that the positive and negative contactor assemblies comprise unidirectional contactors, or contactors with higher ratings for current flow in one direction than the other, the positive contactor assembly may comprise contactor(s) with a first preferred current direction and the negative contactor assembly may comprise contactor(s) with a second preferred current. For example, the negative contactor assembly may have a higher rating when the battery is charging, and the positive contactor assembly may have a higher rating when the battery is discharging. In this example, in response to an instruction to open the contactors it may be preferable to open one or more contactors of the positive contactor assembly prior to opening the negative contactor assembly when the battery is discharging and to open one or more contactors of the negative contactor assembly prior to opening the positive contactor assembly when the battery is charging.

In an event that one or both of the positive and negative contactor assemblies comprise more than one contactor, each contactor of the positive contactor assembly may have the same or different ratings, and each contactor of the negative contactor assembly may have the same or different ratings.

In an example where positive contactor assembly comprises either a main positive contactor or string positive contactors but not both, and the negative contactor assembly comprises either a main negative contactor or string negative contactors but not both, the order in which the positive and negative contactor assemblies are opened may depend on the current direction and on which of the positive and negative contactor assemblies has the higher rating in that current direction.

In an example where the positive and negative contactor assemblies each comprise both the main and string contactors, the priority assigned to the string and main contactors may determine whether the main contactor or the string contactors are opened first. The current direction and corresponding ratings of the contactors may determine whether the positive or negative contactors are opened first. In an example, the priority may be more important than the contactor rating for the current direction, such that both higher priority contactors are opened before the lower priority contactors are opened. In other words, the higher rating contactor of the higher priority contactors is opened first, then the lower rating contactor of the higher priority contactors is opened second. The higher rating contactor of the lower priority contactors may then be opened, and finally the lower rating contactor of the lower priority contactors. In another example, the contactor ratings for the current direction may be more important than the priority, such that both contactors with higher rating for the current direction are opened before the contactors with the lower rating for the current direction. In other words, the higher rating contactor of the higher priority contactors is opened first, then the higher rating contactor of the lower priority contactors is opened second. The lower rating contactor of the higher priority contactors may then be opened, and finally the lower rating contactor of the lower priority contactors.

Referring again to FIG. 3, in an example the battery circuit may comprise a main positive contactor, string positive contactors, a main negative contactor, and a string positive contactor. In a specific example, the main positive contactor may be assigned a higher priority than the string positive contactors. The main negative contactor may be assigned a higher priority than the string negative contactors. The positive contactor assembly may have higher ratings for a discharging current direction, and the negative contactor assembly may have higher ratings for a charging current direction. In this specific example, in response to an instruction to open the contactors when the battery is charging, the main negative contactor may be opened first, followed by the main positive contactor, followed by the string negative contactors, followed by the string positive contactors. In response to an instruction to open the contactors when the battery is discharging, the main positive contactor may be opened first, followed by the main negative contactor, followed by the string positive contactors, followed by the string negative contactors. In this specific example, the higher priority of the main contactors means that both main contactors are opened (in an order based on their ratings) before either of the string contactors are opened.

In some battery circuit architectures, the battery circuit may comprise one or more pre-charge contactors, wherein a pre-charge contactor comprises a capacitor. In an event that the battery circuit comprises one or more pre-charge contactors, the method may further comprise pre-charging a load capacitance of the battery before connecting the battery to the load by charging the voltage level of a machine side to a similar voltage to the battery voltage. This aims to prevent a high inrush current that may damage the battery, the load or current-carrying components. In response to an instruction to close the contactors, the method may comprise a step prior to step 170 of closing one or both pre-charge contactors, and waiting until a voltage rate of increase slows or plateaus and a voltage threshold is met. Once these conditions are met, the method may proceed to step 170 and may close the battery contactors according to the sequence. In an event that the conditions are not met, pre-charge may be considered to have failed and all contactors may be opened.

In an event that the battery circuit comprises more than one string, and the strings each comprise one or more contactors, in response to an instruction to switch the string contactors of a given polarity, the string contactors of a given polarity may be switched simultaneously or one by one.

In an example, in response to an instruction to close the string contactors such that the strings are online (i.e. connected to the battery circuit), the string voltages may be measured. In an event that the battery is discharging, the highest string voltage is identified and the offline strings are sorted from the highest to the lowest voltage. If no strings are online, the string with the highest voltage is brought online. If at least one string is online, the method waits until the difference between the system voltage and the offline string with the highest voltage is within a tolerance. Once this voltage difference is within a tolerance, the offline string with the highest voltage is brought online. This is continued until all strings are online. In an event that the battery is charging, the lowest string voltage is identified and the strings are sorted from the lowest voltage to the highest voltage. If no strings are online, the string with the lowest voltage is brought online. If at least one string is online, the method waits until the difference between the system voltage and the offline string with the lowest voltage is within a tolerance. Once this voltage difference is within a tolerance, the offline string with the lowest voltage is brought online. This is continued until all strings are online.

In another example, the method of opening string contactors may comprise safety measures. The battery current may be measured. In an event that the battery current is less than an individual string contactor capability (or the battery current times a safety factor is less than an individual string contactor capability), in response to an instruction to open the string contactors such that the strings are offline all string contactors of a given polarity may be opened. The polarity depends on the current direction, as discussed above. The string contactors of the other polarity may then be opened. In an event that the battery current is greater than an individual string contactor capability (or the battery current times a safety factor is greater than an individual string contactor capability), in response to an instruction to open the string contactors such that the strings are offline, each string may be brought offline one by one. After each string is brought offline by opening a contactor, the load (current) on the string may be measured. If the load is less than the string contactor capability, the next string is brought offline. If the load is not less than the string contactor capability, no more contactors may be opened and a fuse of the battery may be allowed to blow. The safety factor may be a number greater than 1. For example, the safety factor may be 1.3.

The method of controlling contactor sequencing may apply to opening contactors or closing contactors.

A battery comprising a circuit is provided according to an embodiment of the disclosure, wherein the battery comprises a controller configured to carry out any of the methods described above.

A rating of a contactor (otherwise referred to as a capability) may comprise the maximum current at which a contactor can be opened. The rating may also comprise one or more of a voltage, and a contactor lifetime (for example in number of switching cycles at a certain current and voltage).

In an example of an application of the methods described above, the methods may be used to control contactor sequencing for a battery of an electric work vehicle comprising a plurality of strings.

Although the term contactor has been used, the contactors described above may comprise any switch for an electrical circuit that may be opened and closed by a controller. The contactors may comprise electrically controlled switches or relays.

1. A method of controlling contactor sequencing for a battery, wherein the battery comprises a circuit, the method comprising:
determining an architecture of the circuit, wherein the circuit comprises at least a positive contactor assembly and a negative contactor assembly, wherein:
when the positive contactor assembly comprises more than one positive contactor, assigning a priority to each positive contactor of the positive contactor assembly; and
when the negative contactor assembly comprises more than one negative contactor, assigning a priority to each negative contactor of the negative contactor assembly;
determining a direction of current flow through the circuit, wherein the direction of current flow is indicative of whether the battery is charging or discharging;
determining a first rating of the positive contactor assembly for current flow in a first direction, a second rating of the positive contactor assembly for current flow in a second direction, a third rating of the negative contactor assembly for current flow in a first direction and a fourth rating of the negative contactor assembly for current flow in a second direction;
determining a sequence of switching the positive and negative contactor assemblies based on at least one of:
when the positive contactor assembly comprises more than one positive contactor, the priorities assigned to each of the positive contactors;
when the negative contactor assembly comprises more than one negative contactor, the priorities assigned to each of the negative contactors;
the direction of current flow;
the first and second ratings of the positive contactor assembly; and
the third and fourth ratings of the negative contactor assembly; and
switching the positive and negative contactor assemblies according to the sequence.

2. The method of claim 1 wherein when the current is flowing in the first direction and the first rating is higher than the third rating, a contactor of the positive contactor assembly is first in the sequence.

3. The method of claim 1 wherein when the current is flowing in the first direction and the third rating is higher than the first rating, a contactor of the negative contactor assembly is first in the sequence.

4. The method of claim 1 wherein when the current is flowing in the second direction and the second rating is higher than the fourth rating, a contactor of the positive contactor assembly is first in the sequence.

5. The method of claim 1 wherein when the current is flowing in the second direction and the fourth rating is higher than the second rating, a contactor of the negative contactor assembly is first in the sequence.

6. The method of claim 1 wherein when the positive contactor assembly comprises a main positive contactor and at least one string positive contactor, a first priority is assigned to the main positive contactor and a second priority is assigned to the at least one string positive contactor, wherein:
when the first priority is higher than the second priority, the main positive contactor is higher in the sequence than the at least one string positive contactor; and
when the second priority is higher than the first priority, the at least one string positive contactor is higher in the sequence than the main positive contactor.

7. The method of claim 1 wherein when the negative contactor assembly comprises a main negative contactor and at least one string negative contactor, a third priority is assigned to the main negative contactor and a fourth priority is assigned to the at least one string negative contactor, wherein:
when the third priority is higher than the fourth priority, the main negative contactor is higher in the sequence than the at least one string negative contactor; and
when the fourth priority is higher than the third priority, the at least one string negative contactor is higher in the sequence than the main negative contactor.

8. The method of claim 1 wherein at least one of the positive contactor assembly and the negative contactor assembly comprises a plurality of contactors.

9. The method of claim 8, wherein:
when the battery is charging, the plurality of contactors are opened sequentially from lowest to highest voltage; and
when the battery is discharging, the plurality of contactors are opened sequentially from highest to lowest voltage.

10. The method of claim 1 wherein when the battery is charging and when the circuit further comprises a pre-charge contactor, the method further comprises closing the pre-charge contactor such that a voltage of a load reaches a value equal to the battery voltage.

11. A battery comprising:
a circuit, wherein the circuit comprises a plurality of contactors; and
a controller configured to control contactor sequencing for the battery;
wherein the controller is configured to:
determine an architecture of the circuit, wherein the circuit comprises at least a positive contactor assembly and a negative contactor assembly, wherein:
when the positive contactor assembly comprises more than one positive contactor, assign a priority to each positive contactor of the positive contactor assembly; and
when the negative contactor assembly comprises more than one negative contactor, assign a priority to each negative contactor of the negative contactor assembly;
determine a direction of current flow through the circuit, wherein the direction of current flow is indicative of whether the battery is charging or discharging;
determine a first rating of the positive contactor assembly for current flow in a first direction, a second rating of the positive contactor assembly for current flow in a second direction, a third rating of the negative contactor assembly for current flow in a first direction and a fourth rating of the negative contactor assembly for current flow in a second direction;
determine a sequence of switching the positive and negative contactor assemblies based on at least one of:
when the positive contactor assembly comprises more than one positive contactor, the priority assigned to each of the positive contactors;
when the negative contactor assembly comprises more than one negative contactor, the priority assigned to each of the negative contactors;
the direction of current flow;
the first and second ratings of the positive contactor assembly; and
the third and fourth ratings of the negative contactor assembly; and
switch the positive and negative contactor assemblies according to the sequence.

12. The battery of claim 11, wherein when the current is flowing in the first direction and the first rating is higher than the third rating, a contactor of the positive contactor assembly is first in the sequence.

13. The battery of claim 11, wherein when the current is flowing in the first direction and the third rating is higher than the first rating, a contactor of the negative contactor assembly is first in the sequence.

14. The battery of claim 11 wherein when the current is flowing in the second direction and the second rating is higher than the fourth rating, a contactor of the positive contactor assembly is first in the sequence.

15. The battery of claim 11 wherein when the current is flowing in the second direction and the fourth rating is higher than the second rating, a contactor of the negative contactor assembly is first in the sequence.
